(19) United States
(12) Patent Application Publication
(10) Pub. No.: US 2015/0070512 A1
(43) Pub. Date: Mar. 12, 2015

(54) Test pattern and method of monitoring changes in test pattern characteristics

(71) Applicant: Ferrand D.E. Corley, Mississauga (CA)

(72) Inventor: Ferrand D.E. Corley, Mississauga (CA)

(21) Appl. No.: 14/121,429

(22) Filed: Sep. 5, 2014

Related U.S. Application Data
(60) Provisional application No. 61/959,946, filed on Sep. 6, 2013.

(51) Int. Cl. H04N 17/02

(52) U.S. Cl. CPC H04N 17/02
USPC 348/189

(57) ABSTRACT

A test panel containing test elements, and a control element, and a replica control element, and a method of monitoring the accuracy of color, grayscale and other test image elements subject to degradation through age, exposure, shrinkage, or other causes.

### FIELD OF THE INVENTION

A method of maintaining accuracy of color, grayscale and other test pattern elements subject to degradation through age, exposure, shrinkage, or other causes. This application is based on U.S. Provisional Application No. 61/959,946 filed Sep. 6, 2013; Title: TEST PATTERN AND METHOD OF MONITORING CHANGES IN TEST PATTERN CHARACTERISTICS; Inventor: Ferrand D. E. Corley, the priority of which is claimed.

### BACKGROUND OF THE INVENTION

A major problem in film and television production has always been maintaining consistent color and graytone picture quality.

The problem is exacerbated by the fact that there are so many variables in the production and viewing of color images. Starting with the original scene, there is the spectral reflection of a particular color under different light sources. It is a common reality to own an automobile that looks one color in daylight and totally different colors at night depending on the type of lighting, sodium, HMI, Quartz etc.

Similarly we can have two items having different spectral reflectivity, that appear to be the same color under one light source, but look to be different to each other under another light source.

While this has been a problem since the introduction of discontinuous light sources, fluorescent and gas discharge for example, today, the introduction of LED lighting with an almost infinite variety of spectral distributions makes the potential for inaccurate and inconsistent color reproduction very much worse.

In addition to the variability in color consistency in a scene and the lighting of the scene, there is also variability in the color sensitivity characteristics of different cameras, even cameras of the same make and model.

With film, such differences were limited to the type of film, variation from batch to batch and the characteristics of the lens being used. For example, Japanese lenses have traditionally made bluer looking images than European lenses.

In addition to the color characteristics of the scene, the camera and the light source, we now have to add the color characteristics of the printer, monitor, projector, or other display device.

50 years ago display devices were either tungsten or carbon arc, both of which, while varying in color temperature, featured a continuous spectrum, making color correction and matching relatively simple by adding a colored filter.

Today's monitors and projection equipment have an almost infinite variety of spectral distributions, adding significantly to the issue of producing accurate and/or consistent image quality.

One solution is to use expensive spectrophotometer systems and software to evaluate and match colors. This is impractical due to the cost of both the equipment and of hiring trained operators.

A far more practical approach, and one that is being used with varying degrees of success is, during production, to include a precision test target, having known colorimetric characteristics, at the beginning or end of a scene.

This on-the-set reference enables subsequent color correction and matching during post-production editing.

The success of matching colors and gray tones using this technique is totally governed by the accuracy of the on-the-set test target.

This is the one weakness of an otherwise robust system, that this invention is designed to address.

A test target that includes precision color and grayscale information is a basic measuring tool and may be compared to a ruler, weighing scale, tape measure, or any other precision measuring device.

Over time, mankind has become accustomed to being able to rely on the accuracy of such measuring tools. 100 centimeters on a steel tape will be exactly the same length today as it was 200 years ago and and it may be relied upon to be 100 centimeters for the foreseeable future.

However, unlike steel rules which maintain their precision over time, test targets, that were accurate when manufactured can change significantly over time and, this change can happen very quickly, depending on the environmental conditions, sometimes in a matter of hours, clearly rendering them unreliable as test standards.

Consequently, to maintain an imaging system's precision, requires that test patterns be replaced regularly.

Some users replace charts automatically through lease programs, others replace them as and when they remember, while still others never replace them. This results in some test charts being replaced unnecessarily, which can be expensive and is environmentally undesirable, while others are not replaced, degrade and provide misleading data. This invention provides a solution to the longstanding problem of test chart degradation.

### BRIEF SUMMARY OF THE INVENTION

A test panel, typically used to align image taking and recording systems such as motion and still cameras, incorporates a main test image and a precision control element image. The main test image of the test panel can also be used to control the reproduction characteristics of display devices such as television sets, computer monitors and image projection systems.

In this mode the main test image of the test panel, having been certified accurate as compared with the precision control element is photographed by a camera, previously certified as being accurate in its ability to accurately reproduce colors and gray tones. The electronic signals produced by the camera are then displayed on the television sets, computer monitors and image projection systems and the grayscale and color data displayed is then measured by spectrophotometers or other instrumentation well known in the trade and the data compared to the known aim values provided with the chart. Alternatively, a simple visual evaluation can be made and the quality of the display device assessed by the consistency of the increase in brightness of the grayscale steps, one to the next, and similarly while the hue will obviously change between the various color patches, the consistency in brightness and saturation should remain similar one to the next.

To monitor the accuracy of the main test image, a replica of the precision control element image is produced to original specifications and is provided to users at regular intervals typically annually. Visual, electronic, or digital side-by-side comparison of the replica control element, with the control element image in an aging, or used test panel, enables a user to know the degree of deterioration that has occurred in the control pattern image on the aging test panel and hence any change in the test image itself.

The comparison data provided by vector scopes, spectro-photometers, or other instrumentation, well known in the trade, enables a user to decide when the aging test panel should be replaced, or traded in.

Typically the test panel will be a sheet of material, supported on a frame, or other rigid support with the images printed or shown on the sheet material. The test panel can also be printed on flexible material that is wound on a roller that self extracts into a container, akin to a projection screen, where it may be stored to avoid damage and degradation from light, ozone and other elements known to degrade image quality.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1—is a test panel incorporating a main test image of colors, gray tones, or other test targets, and having a control element image illustrating the invention;

FIG. 2—is a replica control element;

FIG. 3—is a replica control element having non-symmetrical components; and,

FIG. 4—is an example of an aging test panel in which some of the colors or gray tones in both the main test image and the control element have changed relative to an accurate replica control element.

### DESCRIPTION OF A SPECIFIC EMBODIMENT

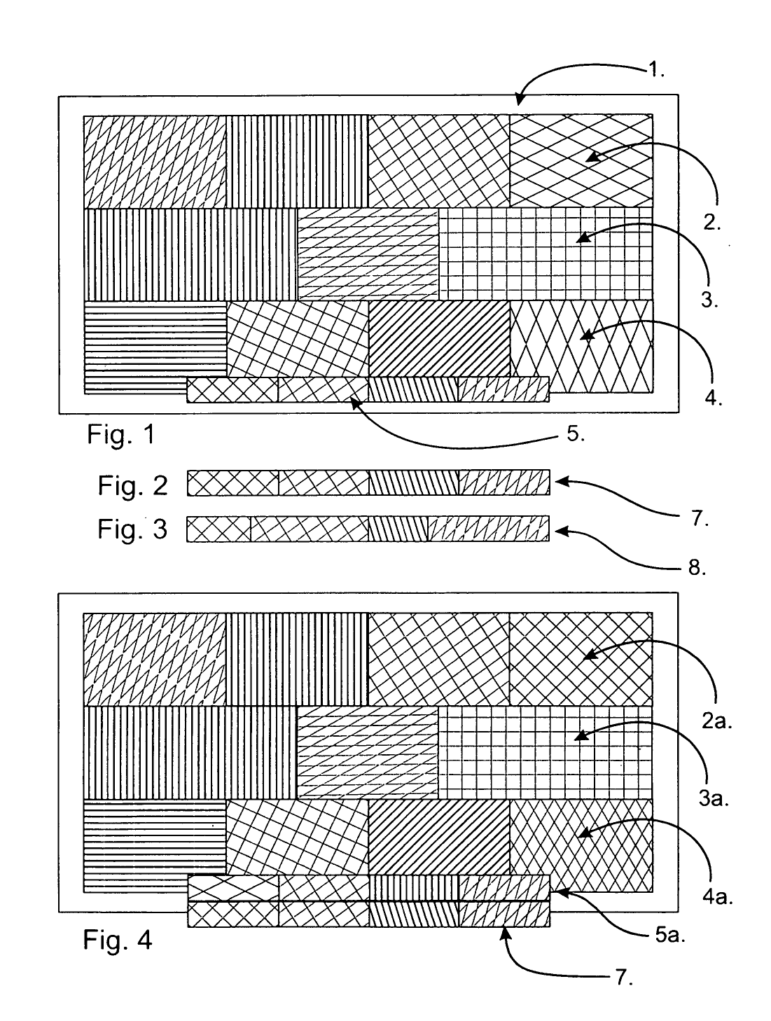

Referring to FIG. 1, a test panel carries a main test image (1) which includes a number of patches of colors (2), from near ultraviolet through blue, green, and red to near infrared, but within the legal color gamut of modern television and digital imaging systems, a Grayscale (3), typically gray toned patches on a neutral background and other test elements, such as resolution gratings (4) these can be sinusoidal, hard-edged, or hyperbolic and are used in controlling image quality and whose use is well known in the trade.

The colors (2), Grayscale (3) and resolution gratings (4) may be produced using aqueous, or solvent based dyes and pigments. The spectral curves of such dyes and pigments shall be smooth to avoid peaks or deep troughs in areas of high spectral sensitivity in cameras and imaging devices, which could result in distorted reproduction of colors. The spectral distribution of the panel on which the colors (2), Grayscale (3) and resolution gratings (4) are deposited or printed should similarly be without spectral spikes or troughs.

The individual patches comprising main test image (1) have a preselected set of colors and gray tones having specific qualities such as are required to maintain the quality of a high definition television signal to the Rec. ITU-R BT.709-5 standard and other ultra high definition systems such as Rec. ITU-R BT.2020

Purchase and shipping of such a test image represents a significant cost to the user and provided the image quality remains at or close to the original specifications, replacement at frequent intervals is generally not necessary.

However, even precision test images change with age, use and handling, exposure to light, other radiation and environmental pollutants. Typically most image degradation is fading. Although there can be significant color shifts, the direction of such changes depend on the stability and longevity of the particular dyes and pigments used in the construction of the image, the changes are frequently towards red and blue.

To monitor the degree of change, a control reference element (5) having test component patches is provided within, or adjacent to main test image (1). In most circumstances four or five reference elements are ideal, with most of these appearing to be neutral. However, neutrality can be achieved a number of ways, using all or predominantly black pigment or a combination of yellow, cyan, magenta, and black, or yellow cyan and magenta without any black. Surprisingly, black pigment can change color from exposure to light and consequently will not necessarily remain neutral and in addition has a propensity to reflect infrared and this can be a problem in test chart manufacture and imaging by a camera. This is the reason for using a number of different patches in evaluating color change. As a general rule it is desirable for the control reference element to use the required levels of yellow, cyan, and magenta to produce a neutral gray, because if one of them fades more than the others, the color shift will be very distinct and more readily measurable.

Typically the control reference element (5) will be part of the main test element itself, and be recorded on the same media.

A frame (6) may support the test element or panel.

FIG. 4 illustrates a test panel in which the image patches are aging and deteriorating. The colours, gray scale and other elements are illustrated as (2a), (3a) and (4a), these correspond to (2), (3), and (4) of FIG. 1.

The control element IN FIG. 4, is illustrated as (5a), and corresponds to the control reference element (5)of FIG. 1.

To determine how much the colors and gray toned patches in test image (1) have changed with age and use and similarly how much the characteristics of control element (5) have changed, a new replica control element (7) (FIG. 2) identical to control element (5) is produced from the same materials to the same level of accuracy and tolerance as the control element (5) within the test panel when it was new.

Typically the replica control elements will be printed on media of a size and shape which can be shipped and supplied at a low cost, at various time intervals. The replica control element (7) will usually be sent out to the end user at, for example yearly intervals. It can be shipped by mail and will not require courier delivery.

Typically the images (1), (5), (7) and (8) are recorded on a media such as photographic paper, high grade glossy or matte digital printing media, or a durable white, spectrophotometrically neutral thermoplastic sheet or panel.

In another embodiment, the control element (5) may be printed separately from the test element (1). Subsequently it may then be fastened by adhesive along side the test element (1) or on a sheet adjacent to it.

To test the level of change that may have occurred in test image (1) the replica control element (7) is placed along side the control element (5a) in the aging test panel (FIG. 4). The user can then compare the replica control element (7) with the control element (5a) in the aging test panel (FIG. 4). Any degradation between control elements (5a) and replica control element (7), can be extrapolated to the main test image itself.

In order to ensure accuracy and eliminate the possibility of using the wrong test element, the design and content of control elements (5) (FIG. 1) and (7) (FIG. 2) are changed annually as in (8) (FIG. 3).

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A test panel for controlling image quality of digitally produced color and black and white images and those transmitted as high definition television signals and comprising; a main test image having colour and gray scale elements, in predetermined values, and, a control element image along side said main test image, said control image containing control elements of predetermined shape, colour, gray scale density and neutrality.

2. A test panel as claimed in claim 1, wherein the control elements are within the test image.

3. A test panel as claimed in claim 1, wherein the control elements are outside the periphery of the test image.

4. A test panel as claimed in claim 1, in which the control elements contain only color and/or gray elements.

5. A test panel as claimed in claim 1, in which the control elements contain only gray elements.

6. A test panel as claimed in claim 1, in which the control element is non-symmetrical.

7. A test panel as claimed in claim 1, in which the control element is separate from the test image and permanently attached to it using adhesives.

8. A test panel as claimed in claim 1, in which the control element is separate from the test image and removably attached to it using adhesives.

9. A test panel as claimed in claim 1, including a replica control element produced on the same media, using the same pigments as the control element images.

10. A test panel as claimed in claim 1, including a replica control element produced on the same media, but using a different family of pigments having different spectral distribution to as the control element images.

11. A test panel as claimed in claim 1, including a replica control element produced on different media, but using a different family of pigments having different spectral distribution from the control element images.

12. A test panel as claimed in claim 1, including a replica control element produced on different media, and using a different family of water based pigments from the control element images.

13. A test panel as claimed in claim 1, including a replica control element produced on different media, and using solvent based pigments as in the control element images.

14. A method of evaluating the characteristics of a test panel having a plurality of images defining specific characteristics of density, hue and colour, and comprising the steps of;
forming a test element having a plurality of test images;
forming a test control element associated with said test element;
forming a replica control element having a plurality of patches with characteristics corresponding to the test control element, when it was made, and,
comparing the test control element with the replica control element.
